(19) United States
(12) Patent Application Publication
(10) Pub. No.: US 2017/0037257 A1
(43) Pub. Date: Feb. 9, 2017

(54) GRAPHENE-BASED COATINGS

(71) Applicant: Board of Regents, the University of Texas System, Austin, TX (US)

(72) Inventors: Duck J. YANG, Flower Mound, TX (US); Daniel N. TRAN, Carrollton, TX (US); Sangmin LEE, McKinney, TX (US)

(21) Appl. No.: 15/304,260

(22) PCT Filed: Apr. 14, 2015
(86) PCT No.: PCT/US15/25693

§ 371 Date: Oct. 14, 2016

Related U.S. Application Data
(60) Provisional application No. 61/979,341, filed on Apr. 14, 2014.

(51) Int. Cl. C09D 5/08; C09D 7/12; C09D 5/16

(52) U.S. Cl. CPC C09D 5/084; C09D 5/1618; C09D 7/1225; C08K 3/04

(57) ABSTRACT

The present disclosure relates to coatings comprising functionalized graphene(s) and polymers (resins). In accordance with the disclosure, graphene can be used with functionalization with polymers (resins) with or without pigments, fillers, reactive catalysts or accelerators as finishes to protect roll steel, galvanized roll steel, equipment, automobiles, ships, construction and marine structures from corrosion, fouling and UV deterioration.

The present application is a national phase application under 35 U.S.C. §371 of International Application No. PCT/US2015/025693, filed Apr. 14, 2015, which claims benefit of priority to U.S. Provisional Application Ser. No. 61/979,341, filed Apr. 14, 2014, the entire contents of each of which are hereby incorporated by reference.

### BACKGROUND

A. Field

The present disclosure relates to coatings comprising graphene and polymers (resins) and potentially fillers and pigments. In accordance with the description, graphene can be used with functionalization with polymers (resins) including reactive catalysts or accelerators as finishes to protect roll steel, galvanized roll steel, automobiles, equipment, ships, construction and marine structures from corrosion, fouling and UV deterioration.

B. Background

The technology encompasses the combination of graphene with polymers to perform as corrosion and fouling resistant and UV absorbing and hydrophobic finishes for roll steel, galvanized roll steel, automobiles, ships, construction and marine structures. The multi-functional properties of graphene such as hydrophobicity, π to π stacking (self-assembly), UV absorption and barrier with a high surface area (2,630 sq·m/gram) provide the finishes with anti-corrosion, anti-fouling, hydrophobic and UV absorbing functions in finishes.

Surface coatings can used to impart articles with desirable properties that are not possessed by the articles themselves or not possessed in a sufficient degree. Many of these drawbacks can be overcome by the use of polymeric materials, which can have cost, weight, processability, and flexibility of design advantages over metals. However, most polymer materials are not intrinsically electrically or thermally conductive enough for many applications. Conductive polymeric resin compositions can be made in some cases by adding fillers to polymers, but high loadings are often required, which can be to the detriment of physical and other properties of the materials, as well as lead to melt processing difficulties when thermoset materials are used, among other possible drawbacks.

Coatings can also be used for countless other applications, including providing moisture resistance, corrosion resistance, UV radiation resistance, abrasion resistance, thermal conductivity, impact resistance, stiffness, and many others.

It would be desirable to obtain coatings that can be used with a wide variety of substrates to provide useful properties.

### SUMMARY

Disclosed and claimed herein is coatings comprising graphene and polymers (resins) and which may further comprise fillers and pigments. Further disclosed and claimed herein is a method for coating a substrate with a coating comprising graphene and polymers (resins) and fillers and pigments.

In one aspect, the present disclosure provides compositions comprising:

(A) functionalized graphene; and

(B) a binder,

wherein the composition is used as a coating. In some embodiments, the binder is a polymeric binder. In some embodiments, the binder is an urethane resin, an epoxy resin, acrylic resin, or an alkyd resin. In some embodiments, the binder comprises two or more components. The binder may also further comprise two components wherein at least one of the components is a resin further comprising a catalyst. In some embodiments, the resin further comprising a catalyst is DPX 1 with DPX 2. The binder may be DPX-170, DPX-171, DPX-172, or DPX-173.

In some embodiments, the functionalized graphene is present in a layer consisting of a depth of 1 to 10 sheets of functionalized graphene. In some embodiments, the depth of the functionalized graphene consists of 1, 2, 3, or 4 sheets through more than 50% of the coating. The coating may comprise from about 0.5-20 wt % of functionalized graphene. In some embodiments, the coating comprises 0.5-10 wt % of functionalized graphene. The coating may comprise 1-5 wt % of functionalized graphene. In some embodiments, the coating comprises 0.5, 0.75, 1, 2, 3, 4, 5, 6, 7, 8, 9, 10, 12.5, or 15 wt %, or any range derivable thereof. In some embodiments, the coating comprises functionalized graphene present in a layer from about 0.001 to 10 μm. The layer may be from about 0.01 to 5 μm or from about 0.05 to 2 μm.

In some embodiments, the functionalized graphene comprises one or more functional groups selected from: amino, cyano, hydroxyl, carboxylic acid, isocyanate, aldehyde, epoxide, urea, or anhydride.

In some embodiments, the compositions further comprise a carrier. The carrier may be water or an organic solvent selected from an aliphatic compound; an aromatic compound; mineral spirits; methyl ethyl ketone; n-butyl acetate; ethanol, isopropanol, t-butyl alcohol; and ethylene glycol, and mixtures thereof. In some embodiments, the aliphatic compound is hexanes. In other embodiments, the aromatic compound is toluene or xylene. The compositions may further comprise a filler. In some embodiments, the filler is treated clays, calcium carbonate powders, alumino-silicate fine powders, fine-particle-size silica aerogel-type pigments, and ultrahigh-molecular-weight polymers such as modified cellulosic polymers, natural polymers like carrageenan, and high-molecular-weight water-soluble polymers. The composition may further comprise a pigment. In some embodiments, the pigment is a fine particle ranging in size from 0.01 to 100 μm like carbon black, TiO₂, Zinc oxide, antimony oxide, iron oxide (inorganic) Zinc powder, aluminum metal flake, or an organic dye selected from the dye classes of diazo, phthalocyanine, or quinacridone compounds, or another pigment known in the art. The compositions may further comprise a dispersant. In some embodiments, the dispersant is alkali polyphosphate, alkali poly-acrylate, poly-ethylene glycol, linear alkylbenzene sulfonate, or other dispersants know in the art

In yet another aspect, the present disclosure provides methods of coating a substrate comprising: applying a composition described herein to the surface of the substrate to form a coating on the surface of the substrate. The substrate may be made of metal or may be made of a polymer. The substrate may be made of fabric, textile, or pulp.

In some embodiments, the coating is from about 0.1 μm to about 10 mm (millimeters) thick. The coating may be from about 0.1 μm to about 300 μm thick. The coating may be from about 5 μm to about 300 μm thick. The coating may be from about 15 μm to about 30 μm thick. In some embodiments, the coating of the composition is applied on top of another coating. In some embodiments, another coating is applied on top of the coating of the composition.

In still another aspect, the present disclosure provides compositions comprising:

(A) functionalized graphene; and

(B) a resin.

In some embodiments, the composition is used as a coating. In some embodiments, the coating is applied to steel. The steel may be galvanized or rolled steel. In some embodiments, the steel has been grit blasted. The coating is a coating may be on a metal substrate, an automobile, a ship, a concrete surface, a marine structure, or a construction structure.

In some embodiments, the functionalized graphene contains at least one chemical group selected from: amine, cyano, carboxylic acid, hydroxyl, isocyanate, aldehyde, epoxide, urea, or anhydride. In some embodiments, the functionalized graphene contains at least one chemical group which comprises a nitrogen containing group.

In some embodiments, the resin is a phenolic resin, a polyester resin, a polyol resin, an epoxy resin, or an isocyanate resin. The resin may be an epoxy resin. The epoxy resin may be bisphenol A diglycidyl ether (DGEBA), bisphenol F epoxy resin, novolac epoxy resin, aliphatic epoxy resin, or glycidylamine epoxy resin, or other epoxy resins known in the art. In other embodiments, the resin is an isocyanate resin. The resin may be methylene diphenyl diisocyanate (MDI), toluene diisocyanate (TDI), hexamethylene diisocyanate (HDI), or isophorone diisocyanate (IPDI), diamine bisphenols, or other isocyanate resins known in the art. In other embodiments, the resin is a polyol resin. The polyol resin may be hydroxy-terminated aliphatic polyol, hydroxyl-terminated polybutadienes, hydroxy-terminated block co-polymeric diol or other polyol resins known in the art. In other embodiments, the resin is a polyester resin. The polyester resin may be polyglycolic acid, polylactic acid, polycaprolactone, polyhydroxyalkanoate, polyhydroxybutyrate, polyethylene adipate, polybutylene succinate, poly(3-hydroxybutyrate-co-3-hydroxyvalerate), polyethylene terephthalate, polybutylene terephthalate, polytrimethylene terephthalate, polyethylene naphthalate, or vectran. In other embodiments, the resin is a phenolic resin. In some embodiments, the resin comprises a cross-linked resin of formaldehyde and phenol or a substituted phenol. The fluoropolymer resin may be partially fluorinated or perfluorinated resins known in the art.

In other embodiments, the composition further comprises a filler or a pigment. In some embodiments, the composition further comprises adding an accelerator. The accelerator may be a metal catalyst, a basic catalyst, an acid catalyst, an azide compound, or a peroxide. The metal catalyst may be dibutyl tin dilaurate or zinc octoate. The basic catalyst may be a tertiary amine. The acid catalyst may be a carboxylic acid, phenol, oxalic acid, hydrochloric acid, or sulfonic acid. The peroxide may be a ketone peroxide, a diacyl peroxide, a dialkyl peroxide, a peroxyester, a peroxyketal, a peroxydicarbonate, or a peroxymonocarbonate.

In some embodiments, the coating is from about 5 μm to about 300 μm thick. The coating may be from about 15 μm to about 30 μm thick. In some embodiments, the surface further comprises one or more additional coatings selected from: an e-coating, a primer, a base coat, or a top coat. The composition may be incorporated into one or more of the additional coatings. The composition may be formulated as a suspension, a solution, a paste, a material in substantially solid form, a free-flowing solid, a viscous solid, or a powder. The composition may be applied to the surface by painting, spin casting, solution casting, printing, electrospray printing, cathodic deposition, brush painting, dip coating, roll coating, or powder coating.

The composition may also exhibit decreased UV degradation compared to a composition without functionalized graphene. The composition may also exhibit decreased corrosion compared to a composition without functionalized graphene. The composition may also exhibit decreased fowling compared to a composition without functionalized graphene. The composition may also exhibit increased hydrophobicity compared to a composition without functionalized graphene. The composition may further exhibit improved adhesion compared to a composition without functionalized graphene.

In yet still another aspect, the present disclosure provides compositions comprising:

(A) a functionalized graphene; and

(B) a resin,

wherein the functionalized graphene is reacted with the resin to form a polymeric resin consisting essentially of functionalized graphene and resin repeating units and the resultant polymeric resin is used as a coating. In some embodiments, the functionalized graphene comprises one or more chemical groups selected from: amine, cyano, carboxylic acid, hydroxyl, isocyanate, aldehyde, epoxide, urea, alkene, aralkene, or anhydride.

The resin may be an epoxy, isocyanate, polyol, polyester, or phenolic resin. The functionalized graphene may comprise one or more amine, carboxylic acid, hydroxy, or urea groups when the resin is an isocyanate resin. The functionalized graphene may comprise one or more amine, anhydride, carboxylic acid, or hydroxyl groups when the resin is an epoxy resin. The functionalized graphene may comprise one or more isocyanate groups when the resin is a polyol resin. The functionalized graphene may comprise one or more alkene, aralkene, or anhydride groups when the resin is a polyester resin. The functionalized graphene may comprise one or more aldehyde groups when the resin is a phenolic resin. In some embodiments, the resin comprises a cross-linked resin of formaldehyde and phenol or a substituted phenol.

The composition may also comprise a filler or a pigment. In some embodiments, the composition further comprises adding an accelerator. The accelerator may be a metal catalyst, a basic catalyst, an acid catalyst, an azide compound, or a peroxide. The metal catalyst may be dibutyl tin dilaurate or zinc octoate. In some embodiments, the basic catalyst is a tertiary amine. In some embodiments, the acid catalyst is a carboxylic acid, phenol, oxalic acid, hydrochloric acid, or sulfonic acid. The peroxide may be a ketone peroxide, a diacyl peroxide, a dialkyl peroxide, a peroxyester, a peroxyketal, a peroxydicarbonate, or a peroxymonocarbonate.

In some embodiments, the coating is from about 5 μm to about 300 μm thick. The coating may be from about 15 μm to about 30 μm thick. In some embodiments, the surface further comprises one or more additional coatings selected from: an e-coating, a primer, a base coat, or a top coat. The composition may be incorporated into one or more of the additional coatings. The composition may be formulated as a suspension, a solution, a paste, a material in substantially solid form, a free-flowing solid, a viscous solid, or a powder. The composition may be applied to the surface by painting, spin casting, solution casting, printing, electrospray printing, cathodic deposition, brush painting, dip coating, roll coating, or powder coating.

The composition may also exhibit decreased UV degradation compared to a composition without functionalized graphene. The composition may also exhibit decreased corrosion compared to a composition without functionalized graphene. The composition may also exhibit decreased fowling compared to a composition without functionalized graphene. The composition may also exhibit increased hydrophobicity compared to a composition without functionalized graphene. The composition may further exhibit improved adhesion compared to a composition without functionalized graphene.

In some aspects, the present disclosure provides articles wherein the article is coated with a composition described herein. In some embodiments, the article is a metal substrate, a car, a ship, a marine instrument, a marine structure, construction equipment, or a construction tool. In some embodiments, the article is made of steel. The steel may be rolled steel or galvanized rolled steel.

In some aspects, the present disclosure provides coatings comprising functionalized graphene and at least one binder (possibly including filler and pigment). The binder may be a polymeric binder. The coating may further comprise one or more carriers, fillers, pigments, or dispersants, electrically conductive polymer. In some embodiments, the coating comprises at least one carbonaceous material other than the functionalized graphene sheets. In some embodiments, the graphene is single sheet graphene or double or 3-4 sheet graphene or combination thereof. In some embodiments, the size of the graphene is 0.05-10 microns. The coating may be 0.05-5 microns. The coating may also be 0.01-2 microns

In still another aspect, the present disclosure provides methods for coating a substrate having a surface, comprising the step of applying a coating comprising functionalized graphene sheets and at least one binder to the surface. The substrate may also comprise a polymeric material. In some embodiments, the substrate is a metal. In other embodiments, the substrate is a fabric, textile, or pulp product.

In still yet another aspect, the present disclosure provides articles coated with a coating comprising functionalized graphene sheets having at least one binder.

In still another aspect, the present disclosure provides graphene-based coatings wherein the coating is used for corrosion protection on a steel surface. The steel surface may be a roll steel surface or a galvanized roll steel surface. The steel surface may be a grit blasted roll steel surface. In some embodiments, the coating is used on automobile surfaces for corrosion protection, UV durability and ease of cleaning. In other embodiments, the coating is used on the surface of ships.

In some embodiments, the coating provides anti-fouling, corrosion protection and UV durability to the coated surface. In some embodiments, the coating is used on the surface of construction and marine structures for anti-fouling, corrosion protection and UV durability. In some embodiments, the coating is used on the surface of concrete structures.

In some embodiments, the coating has a thickness of at least about 5 microns. In other embodiments, the thickness is from 15-30 microns. In some embodiments, the coating has a thickness of 300 microns or less. In some embodiments, the coating is includes in the e-coat, primer, base, and top (clear) coatings to prevent corrosion. In some embodiments, the coating exhibits improved UV-absorption properties. In some embodiments, the coating exhibits improved corrosion-resistant properties. In some embodiments, the coating exhibits improved hydrophobicity and anti-fouling. In some embodiments, the coating exhibits improved adhesion. In some embodiments, the composition comprises functionalized graphene sheets and a resin. The composition may further comprise a pigment or a filler. In other embodiments, the composition further comprises an accelerator. In some embodiments, the accelerator is a peroxide or an amine or acid catalyst.

In some embodiments, the graphene is functionalized with OH, Amine, —COOH, —NHCONH₂ when the resin is isocyanate. In some embodiments, the isocyanate resin is methylene diphenyl diisocyanate (MDI), toluene diisocyanate (TDI), hexamethylene diisocyanate (HDI) or isophorone diisocyanate (IPDI). In some embodiments, the graphene is functionalized with amine, anhydride, hydroxy (OH), or —COOH, when the resin is epoxy. In some embodiments, the epoxy resin can be bisphenol A diglycidyl ether (DGEBA), bisphenol F epoxy resin, novolac epoxy resin, aliphatic epoxy resin or glycidylamine epoxy resin. In some embodiments, the graphene is functionalized with isocyanate when the resin is polyol. The graphene may be functionalized with styrene or anhydride (maleic or phthalic) when the resin is unsaturated polyester resin. In other embodiments, the graphene is functionalized with aldehyde when the resin is phenolic resin.

In some embodiments, the composition is a suspension, solution, paste, materials in substantially solid form containing little or no liquids, free-flowing, viscous, solid, or powder. In some embodiments, the composition may be applied to a substrate using any suitable method, including, but not limited to, painting, spin casting, solution casting, printing (including ink jet printing), electrospray printing, cathodic deposition or painting, brush painting, dip coating, roll coating, or powder coating.

In some embodiments, the accelerator is added in the presence of heat. In other embodiments, the accelerator is added in the absence of heat.

In some embodiments, the accelerator is metal catalyst such as dibutyl tin dilaurate or zinc octoate. In some embodiments, the accelerator is acid catalyst such as a tertiary amine, a carboxylic acid or a phenol. In some embodiments, the accelerator is a peroxide such as a ketone peroxide, a diacyl peroxide, a dialkyl peroxide, a peroxyesters, a peroxyketal, a peroxydicarbonate or a peroxymonocarbonate. In some embodiments, the accelerator is oxalic acid, hydrochloric acid or sulfonate acid.

In some embodiments, the thickness of the composition on a surface of a substrate is 1-100 microns. In some embodiments, the thickness is 20-60 microns (1-2 mils).

Embodiments of the disclosure are also directed to a method for coating a substrate having a surface, comprising the step of applying a coating comprising functionalized graphene sheets and at least one binder (resin) to the surface.

An embodiment of the disclosure is directed to an article coated with a coating comprising functionalized graphene sheets having at least one binder. Other embodiments of the disclosure include the functionalized graphene-based coating wherein the coating is used for corrosion protection on a steel surface; the graphene-based coating, wherein the coating is used on automobile surfaces for corrosion protection, UV durability and ease of cleaning; the graphene-based coating, wherein the coating is used on the surface of ships, wherein the coating provides anti-fouling, corrosion protection and UV durability to the coated surface; the graphene-based coating wherein the coating is used on the surface of construction and marine structures for anti-fouling, corrosion protection and UV durability; the graphene-based coating wherein the coating is used on the surface of concrete structures.

Embodiments of the disclosure are further directed to the graphene-based coating wherein the coating has a thickness of at least about 5 microns, or more preferably at least about 30-60 microns. Certain embodiments of the disclosure are directed to the graphene-based coating wherein the coating has a thickness of 300 microns or less. Further embodiments of the disclosure are directed to a graphene-based coating wherein the coating is includes in the primer (or e-coat), base, and top coatings to prevent corrosion, fouling, and UV deterioration.

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the inherent variation of error for the device, the method being employed to determine the value, or the variation that exists among the study subjects. In some aspects, the term “about” may be used to represent a difference of plus or minus 5%.

It is contemplated that any method or composition described herein can be implemented with respect to any other method or composition described herein.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description. Note that simply because a particular compound is ascribed to one particular generic formula doesn't mean that it cannot also belong to another generic formula.

### BRIEF DESCRIPTION OF THE FIGURES

The following drawings form part of the present specification and are included to further demonstrate certain aspects of the present disclosure. The disclosure may be better understood by reference to one or more of these drawings in combination with the detailed description.

FIG. 1—plots the change in the contact angle as a function of the graphene content.

FIG. 2—plots the function of the coating loss based upon the graphene content in a salt water solution.

FIG. 3—plots the function of the coating loss based upon the graphene content in high humidity.

FIG. 4—plots the change in corrosion from a salt water solution based upon the amount of graphene in the coating after about 1100 hours.

FIG. 5—plots the change in corrosion from a salt water solution based upon the amount of graphene in the coating after about 1500 hours.

FIG. 6—plots the change in contact angle based upon the amount of graphene in an artistic gloss varnish.

FIG. 7—plots the change in contact angle based upon the amount of graphene in an dammar varnish.

FIG. 8—plots the change in contact angle based upon the amount of graphene in an acrylic varnish.

FIG. 9—plots the change in UV absorbance based upon graphene concentration in a gloss varnish.

FIG. 10—plots the change in UV absorbance based upon graphene concentration in a dammar varnish.

FIG. 11—plots the change in UV absorbance based upon graphene concentration in a acrylic varnish.

FIG. 12—shows a representative diagram of a simple graphene enchanced base coat on a marine concrete base structure or metal substrate.

FIG. 13—shows a representative diagram of a simple graphene enchanced base coat on a metal substrate with an additional UV protection graphene top coat.

FIG. 14—shows a representative diagram of an enhanced graphene based coating for automotive vehicles. The graphene enhanced coatings can include the primer, base, and top coatings to prevent corrosion.

### DESCRIPTION OF EXEMPLARY EMBODIMENTS

As used herein, the term “coating” refers to a coating in a form that is suitable for application to a substrate as well as the material after it is applied to the substrate, while it is being applied to the substrate, and both before and after any post-application treatments (such as evaporation, cross-linking, curing, and the like). The components of the coating compositions may vary during these stages.

The coatings comprise functionalized graphene and polymer binders and may optionally comprise additional components, such as at least one carrier like filler, pigment, catalyst, or accelerator other than a binder.

Some non-limiting examples of types of binders include polymeric binders. Polymeric binders (resins) can be thermoplastics or thermosets or modified natural alkyl resins and may be elastomers or fluoropolymers. Binders may also comprise monomers that can be polymerized before, during, or after the application of the coating to the substrate. Polymeric binders may be cross-linked or otherwise cured after the coating has been applied to the substrate. Examples of polymeric binders include polyethers such as poly(ethylene oxide)s (also known as poly(ethylene glycol)s, poly(propylene oxide)s (also known as poly(propylene glycol)s, and ethylene oxide/propylene oxide copolymers, cellulosic resins (such as ethyl cellulose, ethyl hydroxyethyl cellulose, carboxymethyl cellulose, cellulose acetate, cellulose acetate propionates, and cellulose acetate butyrates), and polyvinyl butyral, polyvinyl alcohol and its derivatives, ethylene/vinyl acetate polymers, acrylic polymers and copolymers, styrene/acrylic copolymers, styrene/maleic anhydride copolymers, isobutylene/maleic anhydride copolymers, vinyl acetate/ethylene copolymers, ethylene/acrylic acid copolymers, polyolefins, polystyrenes, olefin and styrene copolymers, urethane resins, isocyante resins. epoxy resins, acrylic latex polymers, polyester acrylate oligomers and polymers, polyester diol diacrylate polymers, UV-curable resins, and polyamide, including polyamide polymers and copolymers.

One method of obtaining graphene is from graphite and/or graphite oxide (also known as graphitic acid or graphene oxide). Graphite may be treated with oxidizing and intercalating agents and exfoliated. Graphite may also be treated with intercalating agents and electrochemically oxidized and exfoliated.

Reduction of graphite oxide to graphene may be by means of chemical reduction using hydrogen gas or other reducing agents. Examples of useful chemical reducing agents include, but are not limited to, hydrazines (such as hydrazine, N1N-dimethylhydrazine, etc.), sodium borohydride, hydroquinone, and the like. For example, a dispersion of exfoliated graphite oxide in a carrier (such as water, organic solvents, or a mixture of solvents) can be made using any suitable method (such as ultrasonication and/or mechanical grinding or milling) and reduced to graphene.

Graphite oxide may be produced by any method known in the art, such as by a process that involves oxidation of graphite using one or more chemical oxidizing agents and, optionally, intercalating agents such as sulfuric acid. Examples of oxidizing agents include nitric acid, sodium and potassium nitrates, perchlorates, hydrogen peroxide, sodium and potassium permanganates, phosphorus pentoxide, bisulfites, and the like. Some potential oxidants include KCIO₄; HNO₃ and KCIO₃; KMnO₄ and/or NaMnO₄; KMnO₄ and NaNO₃; K₂S₂O₈ and P₂O₅ and KMnO₄; KMnO₄ and HNO₃; and HNO₃. One intercalation agent includes sulfuric acid. Graphite may also be treated with intercalating agents and electrochemically oxidized. Graphite may also be treated with intercalating agents and electrochemically oxidized to be exfoliated to individual graphene oxide (GO) sheet or sheets by using sonication or other methods. The GO products, reduces or as prepared are commercially available. Furthermore, graphene oxide can be further functionalized with an amine, a hydroxyl, or carboxylic acid as described in the literature.

The coatings may optionally contain electrically conductive components other than the functionalized graphene such as metals (including metal alloys), conductive metal oxides, polymers, carbonaceous materials other than the high surface area functionalized graphene sheets, and metal-coated materials. These components can take a variety of forms, including particles, powders, flakes, foils, needles, etc.

The coatings may optionally contain fillers or pigments other than the functionalized graphene such as silica, fumed silica, alumina, calcium carbonate, zeolite and clays or TiO2 and other color pigments known in the art. The coatings may also optionally contain catalysts or accelerator including hardener other than the functionalized graphene to promote a fast curing of coatings as well as better cross-linking of thermoset coatings.

In certain embodiments of the disclosure, the coating is composed of two parts: Part A contains functionalized graphene sheets and Part B contains reactive resin or a resin with a catalyst or accelerator incorporated. An accelerator (amine or acid catalyst) can be therefore included in part A. When isocyanate resin is used with a functionalized graphene, the functionalized group can be hydroxyl, amine, urea, and other functional groups known to react with isocyanate resin in the art and the isocyanate resin can be methylene diphenyl diisocyanate (MDI), toluene diisocyanate (TDI), hexamethylene diisocyanate (HDI) or isophorone diisocyanate (IPDI) or other known isocyanate resins.

When epoxy resin is used, the functionalized group can be amine, anhydride or hydroxyl (OH) and the epoxy resin can be bisphenol A diglycidyl ether (DGEBA), bisphenol F epoxy resin, novolac epoxy resin, aliphatic epoxy resin or glycidylamine epoxy resin, or other known epoxy resins.

When polyol resin is used, the functionalized group can be isocyanate. When unsaturated polyester resin is used, the functionalized group can be styrene or anhydride such as maleic or phthalic anhydride when phenolic resin is used, the functionalized group can be aldehyde.

The ratio of total number of functional group from graphene in Part A to the total number of functional group from resin in Part B is preferably 1-3 and most preferably close to 1

The weight % of graphene in solids once Part A and Part B is mixed is in the range of 0.1-10%, preferably 1-5%.

The size of graphene is 0.01-25 microns, preferably, 0.1-10 microns, most preferably 0.05-0.50 microns. Functionalized graphene can be a single layered graphene sheet, double layered, triple layered or combination thereof, and preferably single layered graphene.

In certain embodiments, the coating is composed of one Part: water-based latex paints; and solvent-based paints, interior and exterior, primer and sealer.
1) Water-based latex paints or primer: functionalized graphene where X═OH, COOH or Ketone or —NH₂; weight % of graphene in solids in the paint is in the range of 0.1-10%, preferably 1-5%.
2) Solvent-based paints, primer: functionalized graphene where X=Ketone or none; Weight % of graphene in solids in the paint is in the range of 0.1-10%, preferably 1-5%.
3) Silicone sealant: functionalized graphene where X=Ketone or none; Weight % of graphene in solids in the paint is in the range of 0.1-10%, preferably 1-5%.
4) Electro-deposition coating: Waterborne cathodic electrodeposition (CED) coating compositions comprising resin solids and optionally pigments, fillers and conventional coating additives, wherein said CED coating compositions comprise at least one graphene compound in a quantity of 0.1 to 5 wt. % where X can be OH, COOH, NH₂, NCO, Epoxy when it was reacted with resin.
5) Powder coating: Powder coating resin is prepared by a resin synthesis followed by removing solvent thru spray drying. The functionalized graphene is added during the resin synthesis. Weight % of graphene in solids is in the range of 0.1-10%, preferably 1-5%. X can be dependent of kind of resin. For instance, if the resin is a urethane, X can be OH, COOH or —NH₂.

The current technology for ship base coats involves grit blasting followed by application of zinc powder with organosilane binders which is not only labor intensive but hazardous to health. These coatings are required to be stripped and reapplied periodically which can be costly. In addition, current anti-fouling paints contained either toxic copper oxide or silane base resin system having on-purpose peeling property to be fouling resistance. In contrast to it, described herein the enhancement of hydrophobicity of top coating may be used to increase the anti-fouling effects of the top coating. To have adequate corrosion and fouling protection, currently available compositions coat thicker coating (>300 microns) which requires deeper grit blasting to sustain adhesion between substrate and coating. Since the claimed system does not use peeling to be anti-fouling and enhance corrosion protection of each layer, the thickness can be reduced. The reduction of thickness will save a lot of material and labor cost and reduce VOC release, and make the claimed system become a humane friendly and environmentally friendly system.

### Use of the Finishes (Two Parts or One Part)

Purposes/benefits: Corrosion resistant, water resistant, fouling resistant and UV durable coating.

Applications: equipment, automobiles, ships, architectural buildings, bridges, civil and marine structures

Automotive: e-coat, primer, base coat and color coat and clear coat (1-2 mil thickness each)

Body shop: primer, base coat and color coat and clear coat (1-2 mil thickness each)

Ship & marine structure: primer and top coat. Besides the benefits, the present formulation will reduce degree of grit blasting (less surface roughness) and thinner coating vs. current coating system: significant labor cost savings and alleviate environmental problem of current system. Current primer has zinc dust in composition but our graphene based finish can reduce the amount of its use or eliminate its use.

### Methods of Application

Spray—cars, ships, structures

Flow—roll steels

Brush—home

Roll—home

Electrodeposition (cathodic)—cars, roll steel

Powder coating—cars, appliances

Examples of metals used in the compositions include, but are not limited to silver, copper, aluminum, platinum, palladium, nickel, chromium, gold, bronze, and the like. Examples of metal oxides include titanium oxide, antimony tin oxide and indium tin oxide and color pigments, and materials such as fillers coated with metal oxides. Metal and metal-oxide coated materials include, but are not limited to metal coated carbon and graphite fibers, metal coated glass fibers, metal coated glass beads, metal coated ceramic materials (such as beads), and the like. These materials can be coated with a variety of metals, including nickel.

Examples of electrically conductive polymers include, but are not limited to, polyacetylene, polyethylene dioxythiophene, polyaniline, polypyrroles, and the like.

Examples of carbonaceous materials other than graphene include, but are not limited to, carbon black, graphite, carbon nanotubes, vapor-grown carbon nanofibers, carbon fibers, metal coated carbon fibers.

The coatings may optionally comprise one or more carriers in which some or all of the components are dissolved, suspended, or otherwise dispersed or carried. Examples of suitable carriers include, but are not limited to, water, distilled or hydrocarbons.

The coatings may optionally comprise one or more additional additives, such as dispersion aids (including surfactants, emulsifiers, and wetting aids), adhesion promoters, thickening agents (including clays), defoamers and antifoamers, biocides, additional fillers, flow enhancers, stabilizers, cross-linking and curing agents, and the like. In one embodiment of the present disclosure, the surfactant is at least one ethylene oxide/propylene oxide copolymer.

The (graphene or) functionalized graphene is present in the coating in at least about 0.01-5.0 weight percent based on the total weight of the coating. In one embodiment of the disclosure, the functionalized graphene is preferably present in the coatings in at least about 0.01-2.0 weight percent, or more preferably in at least about 0.05 weight percent, or yet more preferably in at least about 0.1 weight percent, or still more preferably in at least about 2.0 weight percent, or even more preferably in at least about 1-2 weight percent, where the weight percentages are based on the total weight of the coating solids after it has been applied to a substrate and subjected to any post-application treatments (such drying, curing, cross-linking, etc.). However, as will be appreciated by those skilled in the art, the amount of functionalized graphene present in the coatings can be selected based on the desired properties and the particular binders and other optional components chosen.

In one embodiment of the present disclosure, the coatings are electrically conductive. The coatings may be made using any suitable method, including wet or dry methods and batch, semi-continuous, and continuous methods. The resulting blends may be further processed by grinding using wet or dry grinding technologies or sonication. The technologies can be continuous or discontinuous. Examples include ball mills, attrition equipment, sandmills, and horizontal and vertical wet grinding mills, bath sonication or probe sonication. Suitable materials for use as grinding media include metals, carbon steel, stainless steel, ceramics, stabilized ceramic media (such as yttrium stabilized zirconium oxide), PTFE, glass, tungsten carbide, and the like. After blending and/or grinding steps, additional components may be added to the coatings, including, but not limited to, thickeners, viscosity modifiers, and the like. The coatings may also be diluted by the addition of more carrier.

After they have been applied to a substrate, the coatings may be cured using any suitable technique, including drying and oven-drying (in air or another inert or reactive atmosphere), UV curing, IR curing, microwave curing or drying, and the like. The coatings may be applied to a wide variety of substrates, including, but not limited to, metals; polymeric materials; fabrics (including cloths) and textiles; glasses and other minerals; ceramics; silicon surfaces; wood; pulp-based materials such as paper, and cardboard; silicon and other semiconductors; laminates; concrete, bricks, and other building materials; and the like. The substrates may have been treated with other coatings or similar materials before the coatings of the present disclosure are applied.

The coatings may be in a variety of forms, including, but not limited to, suspensions, solutions, pastes, and materials in substantially solid form like powders containing little or no liquids. They may be free-flowing, viscous, solid, powdery, and the like.

The coatings may be applied to a substrate using any suitable method, including, but not limited to, painting, spin casting, solution casting, printing (including ink jet printing), electrospray printing or painting, dip coating, cathodic deposition, powder coating, and other methods known in the art. The coatings can be applied in multiple layers. When applied to a substrate, the coatings can have a variety of forms. They can be present as a film or lines, patterns, and other shapes. The coatings may be covered with additional material, such as overcoatings, varnishes, polymers, fabrics, and the like.

When applied to a substrate, the coatings can have a variety of thicknesses. In one embodiment of the disclosure, when applied to a substrate the coating can preferably have a thickness of at least about 5 microns, or more preferably at least about 15 microns. In various embodiments of the disclosure, the coatings can have a thickness of about 5 microns to 2 mm, about 15 microns to 1 mm, about 5 microns to about 30 microns, about 5 microns to about 90 microns, about 5 microns to about 300 microns, about 5 microns to about 1 mm, about 15 microns to about 90 microns, about 15 microns to about 300 microns, about 15 microns to about 1 mm.

The coatings can be applied to the same substrate in varying thicknesses at different points and can be used to build up three-dimensional structures on the substrate.

Some of the purposes and benefits of the coatings is corrosion resistance, water resistance, fouling resistance and UV durable coating. Applications for the coating include equipment, auto, ship, architectural building, bridges, civil and marine structures. In automotive applications, the coating can be used as an e-coat, primer, base coat and color coat and clear coat (1-2 mil thickness each). In ship and marine structures, the coating can be used as a primer and top coat. The amount of functionalized graphene in each coating can also vary.

Besides the benefits, the coating reduces the degree of grit blasting (less surface roughness) and thinner coating vs. current coating system. Additionally, significant labor cost savings are realized along with alleviation of the environmental problem of current system. Current primer has zinc dust in composition but the graphene based finish can reduce the amount of its use or eliminate its use.

The coatings can also be used for the passivation of surfaces, such as metal (e.g. steel, aluminum, etc.) surfaces, including exterior structures such as bridges and buildings. Examples of other uses of the coatings of the disclosure include: UV radiation resistant coatings, abrasion resistant (lubricant) coatings, coatings having permeation resistance to liquids (such as hydrocarbon, alcohols, water, and the like) and ions and/or gases, electrically conductive coatings, static dissipative coatings, and impact resistant coatings. They can be used to make fabrics having electrical conductivity. The coatings can be used in solar cell applications; signage, flat panel displays; flexible displays, including light-emitting diode, organic light-emitting diode, and polymer light-emitting diode displays; backplanes and front planes for displays; and lighting, including electroluminescent and OLED lighting.

### DEFINITIONS

When used herein, carbon based groups comprise from 1 to 18 carbons or in other embodiments, from 1 to 12 carbons. The range of carbon atoms is limited by the minimal number of carbon atoms for that particular group. By way of an example, aryl groups must comprise a minimal number of 5 carbon atoms. Also, as used herein, the term micron is used interchangeably with μm. In some aspects, the chemical terms when used in the context of functionalized graphene comprise a chemical group attached to one or more carbon atoms of the graphene layer. The term “amine” is the group —NR₂ wherein each R is either hydrogen, an aliphatic group, or an aromatic group. The term “alkene” or “aralkene” is a carbon group which comprises at least one non-aromatic carbon carbon double bond. The term “aldehyde” represents the group —C(O)H. The term “carboxylic acid” represents the group —C(O)OR, wherein R is hydrogen, an aliphatic group, or an aromatic group. The term “cyano” represents the group —C≡N. The term “isocyanate” represents the group, —N═C═O. The term “hydroxyl” represents the group, —OH. The term “urea” represents the group —NHC(NH₂)NH₂. The term “epoxide” represents a divalent group which is attached to two carbon atoms of the graphene and forms a three membered ring with an oxygen atom and two carbon atoms of the graphene or one carbon atom from the graphene and another carbon atom. The term “aldehyde” represents the divalent group, —C(O)OC(O)—, wherein the group is joined to two different carbon atoms of the graphene backbone.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The term “effective,” as that term is used in the specification and/or claims, means adequate to accomplish a desired, expected, or intended result.

The above definitions supersede any conflicting definition in any reference that is incorporated by reference herein. The fact that certain terms are defined, however, should not be considered as indicative that any term that is undefined is indefinite. Rather, all terms used are believed to describe the disclosure in terms such that one of ordinary skill can appreciate the scope and practice the present disclosure.

### EXAMPLES

The following examples are included to demonstrate preferred embodiments of the disclosure. It should be appreciated by those of skill in the art that the techniques disclosed in the examples which follow represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1

### Sample Preparation

A 2″×2″ steel substrate was washed and dried with soap, xylene, and isopropanol. The surface was roughed with sandpaper and rewashed with isopropanol and dried. A graphene composition was dispersed in DPX 172 at 1%, 2% and 4% by final weight using bath sonication. The graphene mixed DPX 172 was then mixed with DPX 171 (DPX 172 & 171 are 2K epoxy coating from PPG). The cleaned steel pieces were then dipped in mixed DPX 171/DPX 172/graphene solution and air dried vertically for a total of three coating cycles.

Contact Angle Measurement.

Contact angle was measured by first placing the coated steel samples horizontally flat with the addition of a drop of DI water on the surface of the flat edge. A digital image was from the edge and water droplet angle was measured.

Results.

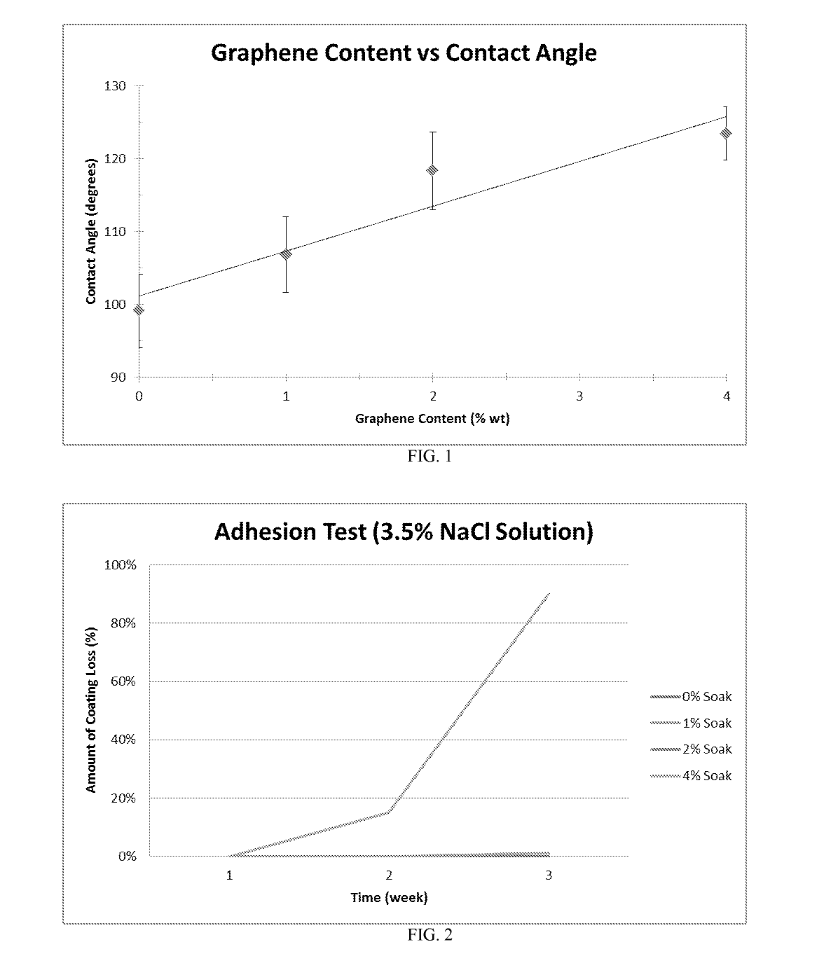

FIG. 1 indicates as the graphene content in the coating increases, so does the hydrophobic nature and thus contact angle. This indicates increase presence of the graphene composition in the coating has an increasing hydrophobic effect on the coating's surface.

### Example 2

### Sample Preparation

2″×2″ steel substrate were washed and dried with soap, xylene, and isopropanol. The surface was roughed with sandpaper and rewashed with isopropanol and dried. Graphene was dispersed in DPX 172 at 1%, 2% and 4% by final weight using bath sonication. The graphene mixed DPX 172 was then mixed with DPX 171. The cleaned steel pieces were then dipped in mixed DPX 171/DPX 172/graphene solution and air dried vertically for a total of three coating cycles.

Adhesion Test.

Coating adhesion was test using ASTM D 3359 standard test for measuring adhesion by tape test. A 5 by 5 square grid (˜2×2 cm) was etched in the center of the coated sample on 1 side of the sample exposing the metal surface under the coating. The sample was then exposed to a 3.5% NaCl solution and scotch tape was applied across the grid surface ensuring good contact. The scotch tape was then removed quickly and the remaining amount of coating on the grid was recorded

Results.

FIG. 2 indicates most solution behave similarly in 3.5% NaCl water. In the case of the 4% graphene content, without wishing to be bound by any theory, the graphene might have a delamination effect.

### Example 3

### Sample Preparation

2″×2″ steel substrate were washed and dried with soap, xylene, and isopropanol. The surface was roughed with sandpaper and rewashed with isopropanol and dried. The graphene composition was dispersed in DPX 172 at 1%, 2% and 4% by final weight using bath sonication. The graphene mixed DPX 172 was then mixed with DPX 171. The cleaned steel pieces were then dipped in mixed DPX 171/DPX 172/graphene solution and air dried vertically for a total of three coating cycles.

Adhesion Test.

Coating adhesion was test using ASTM D 3359 standard test for measuring adhesion by tape test. A 5 by 5 square grid (˜2×2 cm) was etched in the center of the coated sample on 1 side of the sample exposing the metal surface under the coating. The sample was then exposed to a high humidity conditions and scotch tape was applied across the grid surface ensuring good contact. The scotch tape was then removed quickly and the remaining amount of coating on the grid was recorded

Results.

FIG. 3 also shows the same trend for 3.5% NaCl solution conditions.

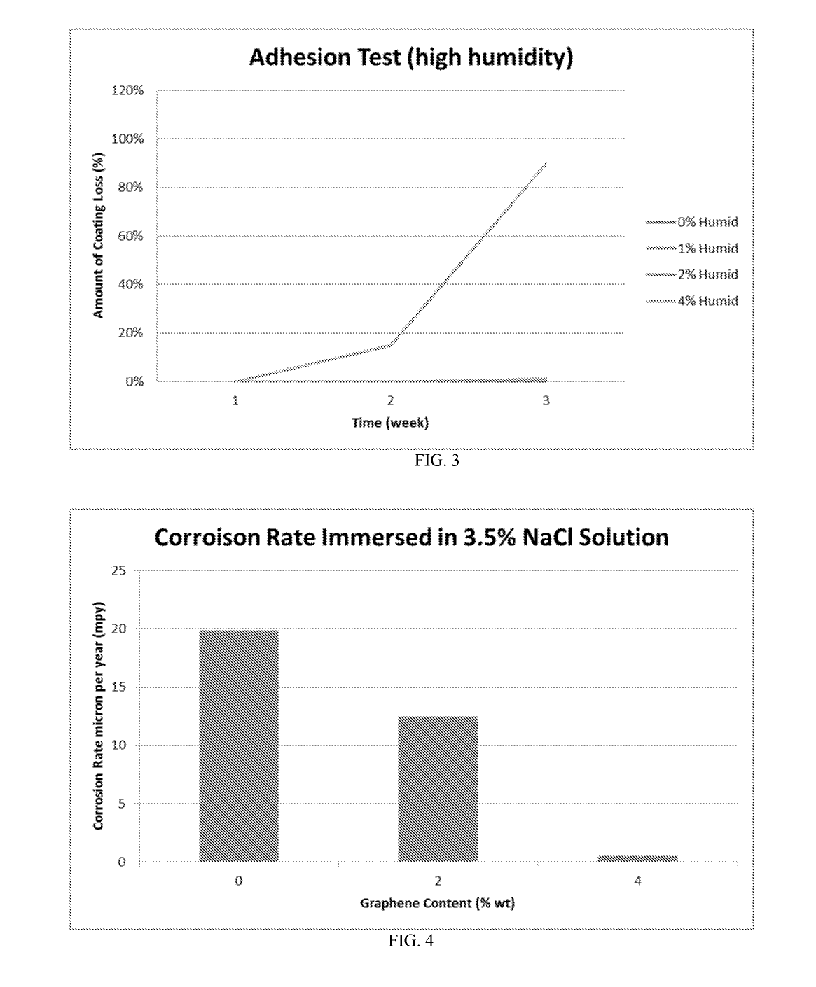

TABLE (1)
Raw Data for FIG. 4 - ASTM G111 - 97(2013)

| | Coating Type | | |
|---|---|---|---|
| | 0% | 2% | 4% |
| Corrosion Rate | 19.8661 mpy | 12.5012 mpy | .5421 mpy |

Note:
micron per year (mpy)
Test period: 1123 hours in 3.5% NaCl solution at room temperature

### Example 4

### Sample Preparation

2″×2″ steel substrate were washed and dried with soap, xylene, and isopropanol. The surface was roughed with sandpaper and rewashed with isopropanol and dried. The graphene composition was dispersed in DPX 172 at 1%, 2% and 4% by final weight using bath sonication. The graphene mixed DPX 172 was then mixed with DPX 171. The cleaned steel pieces were then dipped in mixed DPX 171/DPX 172/graphene solution and air dried vertically for a total of three coating cycles.

Corrosion Test.

Corrosion rate was tested by first weighting and measuring of surface area of the coated steel samples. Each sample was then placed in a 3.5% NaCl solution. With constant replacement of 3.5% NaCl solution and a minimal time of 5 weeks, each sample was then removed from the solution, washed with DI water and acetone, and dried. Rust was then removed by washing with 4M HCl and samples were washed with water again and dried in a 100° C. oven. Samples were washed and dried in a similar manner with HCl until sample weight is stabilized. Corrosion rate was measured using the formula:

$$\frac{K \times W}{A \times T \times D} ,$$

where density of the metal is 7.9 g/cm³.

Results.

Table 1 and FIG. 4 indicates increased amount of Graphene used in the coating significantly lowers the corrosion rate; as we predicted, in fact the hydrophobic property of graphene successfully resists the moisture and acts as a high surface corrosion barrier therefor the reduction of corrosion rate.

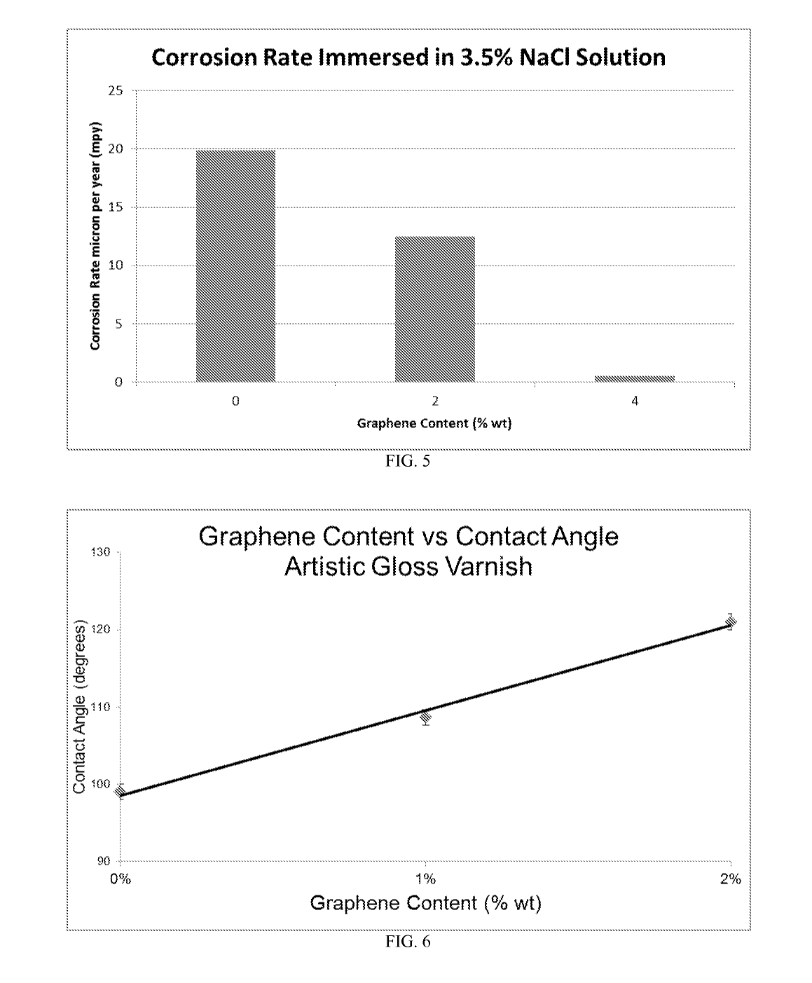

TABLE (2)
Raw Data for FIG. 5 - ASTM G111 - 97(2013)

| | Coating Type | | |
|---|---|---|---|
| | 0% | 2% | 4% |
| Corrosion Rate | 32.560 mpy | 18.921 mpy | N/A |

Note:
micron per year (mpy)
Test period: 1459 hours in 3.5% NaCl solution at room temperature

### Example 5

### Sample Preparation

2″×2″ steel substrate were washed and dried with soap, xylene, and isopropanol. The surface was roughed with sandpaper and rewashed with isopropanol and dried. The graphene composition was dispersed in DPX 172 at 1%, 2% and 4% by final weight using bath sonication. The graphene mixed DPX 172 was then mixed with DPX 171. The cleaned steel pieces were then dipped in mixed DPX 171/DPX 172/graphene solution and air dried vertically for a total of three coating cycles.

Corrosion Test.

Corrosion rate was tested by first weighting and measuring of surface area of the coated steel samples. Each sample was then placed in a 3.5% NaCl solution. With constant replacement of 3.5% NaCl solution and a minimal time of 5 weeks, each sample was then removed from the solution, washed with DI water and acetone, and dried. Rust was then removed by washing with 4M HCl and samples were washed with water again and dried in a 100° C. oven. Samples were washed and dried in a similar manner with HCl until sample weight is stabilized. Corrosion rate was measured using the formula:

$$\frac{K \times W}{A \times T \times D} ,$$

where density of the metal is 7.9 g/cm³.

Results.

Table 2 and FIG. 5 is an extended study of the corrosion rate and the increased graphene content on the coating continues to increase corrosion protection

TABLE (3)
Raw Data for FIG. 6

| | Graphene content (% wt) | | |
|---|---|---|---|
| | 0% | 1% | 2% |
| Contact Angle | 99 ± 2.65 | 109 ± 2.89 | 121 ± 3.61 |

### Example 6

### Sample Preparation

Quartz slides were first cleaned by washing with DI water and 1M HCl and dried. The graphene composition was dispersed in toluene at 1% and 2% (by weight) by bath sonication. Commercial artistic gloss varnish was mixed with the graphene/toluene dispersion. Cleaned quartz slides were then dip coated in the graphene/top coat dispersion and air dried for a total of 3 cycles.

Contact Angle Measurement.

Contact angle was measured by first placing the coated quartz samples horizontally flat with the addition of a drop of DI water on the surface of the flat edge. A digital image was from the edge and water droplet angle was measured.

Results.

Table 3 and FIG. 6 contact angle measurements vs graphene content for artistic gloss varnish. With increased graphene content, hydrophobicity of the coating is increased.

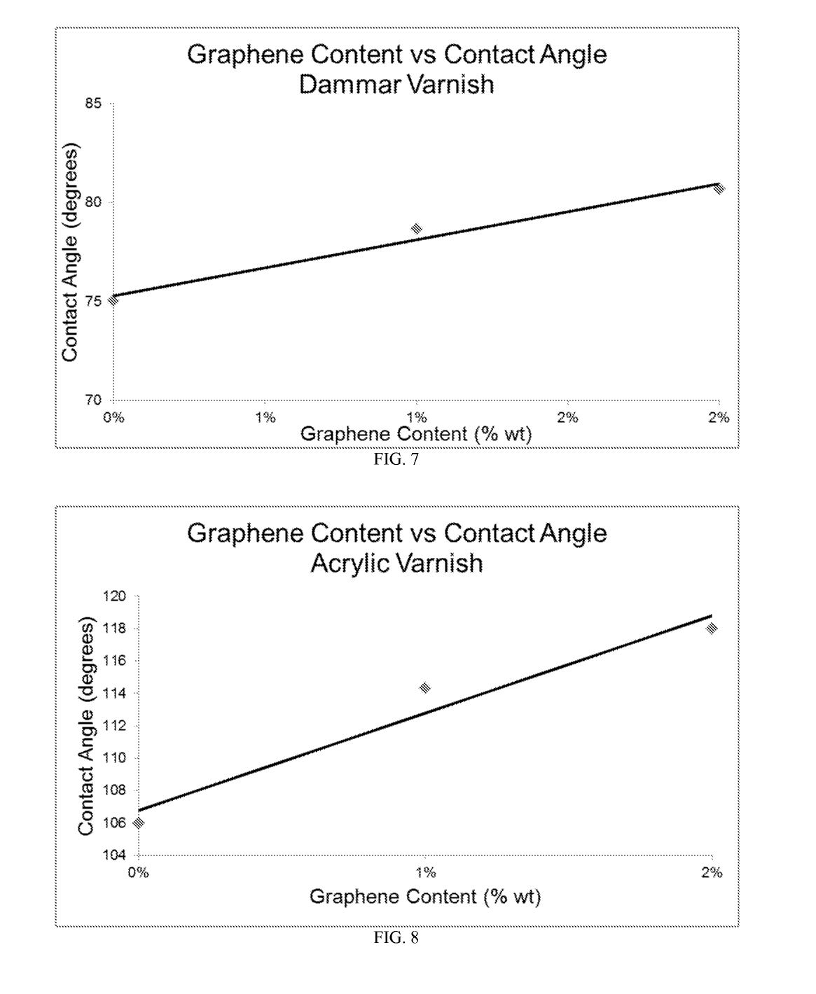

TABLE (4)
Raw Data for FIG. 7

| | Graphene content (% wt) | | |
|---|---|---|---|
| | 0% | 1% | 2% |
| Contact Angle | 75 ± 14.18 | 79 ± 2.08 | 81 ± 4.16 |

### Example 7

### Sample Preparation

Quartz slides were first cleaned by washing with DI water and 1M HCl and dried. The graphene composition was dispersed in toluene at 1% and 2% (by weight) by bath sonication. Commercial Dammar varnish was mixed with the graphene/toluene dispersion. Cleaned quartz slides were then dip coated in the graphene/top coat dispersion and air dried for a total of 3 cycles.

Contact Angle Measurement.

Contact angle was measured by first placing the coated quartz samples horizontally flat with the addition of a drop of DI water on the surface of the flat edge. A digital image was from the edge and water droplet angle was measured.

Results.

Table 4 and FIG. 7 contact angle measurements vs graphene content for Dammar varnish. With increased graphene content, hydrophobicity of the coating is increased.

TABLE (5)
Raw Data for FIG. 8

| | Graphene content (% wt) | | |
|---|---|---|---|
| | 0% | 1% | 2% |
| Contact Angle | 106 ± 6.00 | 114 ± 4.16 | 118 ± 6.24 |

### Example 8

### Sample Preparation

Quartz slides were first cleaned by washing with DI water and 1M HCl and dried. The graphene composition was dispersed in water at 1% and 2% (by weight) by bath sonication. Commercial acrylic varnish was mixed with the graphene/toluene dispersion. Cleaned quartz slides were then dip coated in the graphene/top coat dispersion and air dried for a total of 3 cycles.

Contact Angle Measurement.

Contact angle was measured by first placing the coated quartz samples horizontally flat with the addition of a drop of DI water on the surface of the flat edge. A digital image was from the edge and water droplet angle was measured.

Results.

Table 5 and FIG. 8 contact angle measurements vs graphene content for acrylic varnish. With increased graphene content, hydrophobicity of the coating is increased.

### Example 9

### Sample Preparation

Quartz slides were first cleaned by washing with DI water and 1M HCl and dried. The graphene composition was dispersed in toluene at 2% and 7% (by weight) by bath sonication. Commercial gloss varnish was mixed with the graphene/toluene dispersion. Cleaned quartz slides were then dip coated in the graphene/top coat dispersion and air dried for a total of 3 cycles.

UV Measurements.

UV absorption was measured by placing the quartz slide in a UV-Vis spectrophotometer and reading from 400 to 200 nm with a blank quartz slide as control.

Results.

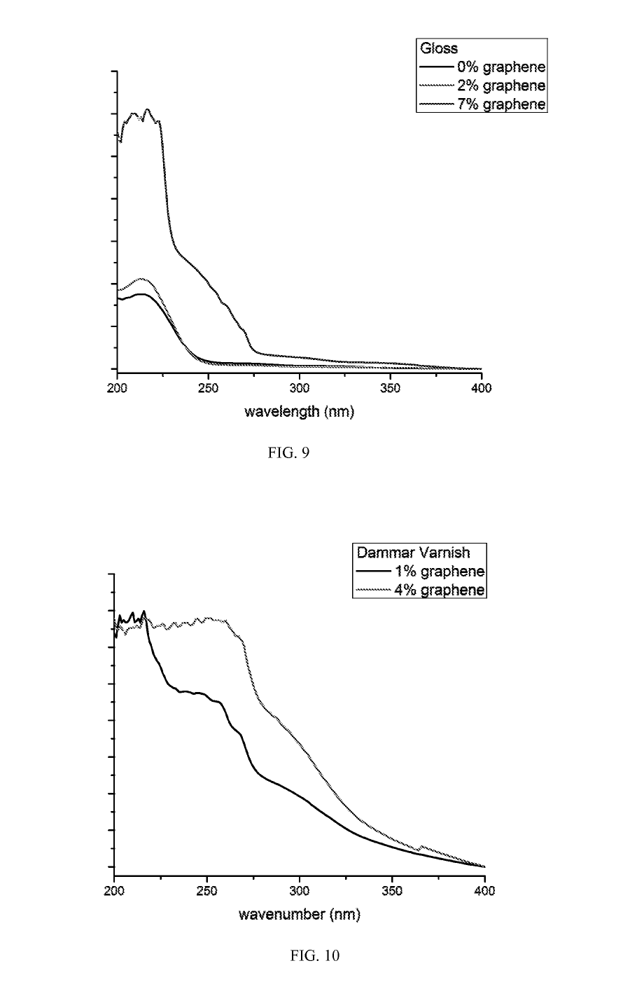

FIG. 9 shows an increase the UV absorption when increase concentration of graphene, when graphene is mixed into gloss varnish. The gloss varnish contains UV protectant and a great improvement is not seen with low graphene content. However when graphene content is increased to 7% then a great improvement in UV absorbance is observed.

### Example 10

### Sample Preparation

Quartz slides were first cleaned by washing with DI water and 1M HCl and dried. The graphene composition was dispersed in toluene at 1% and 2% (by weight) by bath sonication. Commercial gloss varnish was mixed with the graphene/toluene dispersion. Cleaned quartz slides were then dip coated in the graphene/top coat dispersion and air dried for a total of 3 cycles.

UV Measurements.

UV absorption was measured by placing the quartz slide in a UV-Vis spectrophotometer and reading from 400 to 200 nm with a blank quartz slide as control.

Results.

FIG. 10 shows an increase the UV absorption when graphene is mixed with the dammar varnish.

### Example 11

### Sample Preparation

Quartz slides were first cleaned by washing with DI water and 1M HCl and dried. The graphene composition was dispersed in water at 1% and 2% (by weight) by bath sonication. Commercial gloss varnish was mixed with the graphene/toluene dispersion. Cleaned quartz slides were then dip coated in the graphene/top coat dispersion and air dried for a total of 3 cycles.

UV Measurements.

UV absorption was measured by placing the quartz slide in a UV-Vis spectrophotometer and reading from 400 to 200 nm with a blank quartz slide as control.

Results.

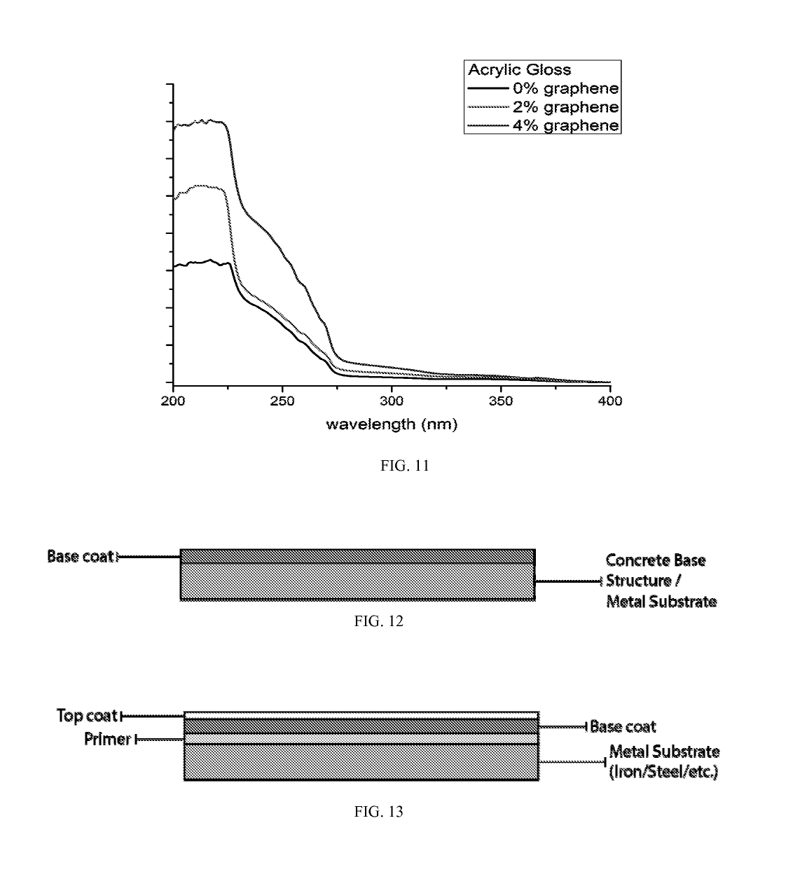

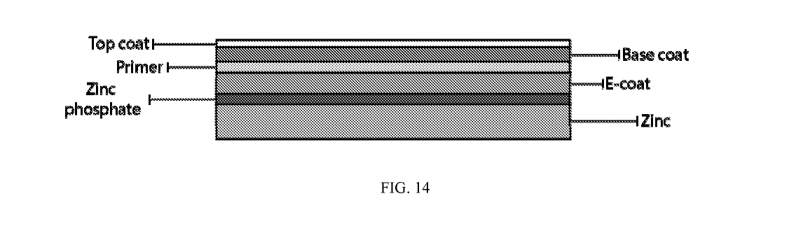

FIG. 11 shows an increase the UV absorption when graphene is mixed with acrylic varnish. FIG. 12 is a representative diagram of a simple graphene enhanced base coat on a marine concrete base structure or metal substrate. FIG. 13 is a representative diagram of a simple graphene enhanced base coat on a metal substrate with an additional UV protection graphene top coat. FIG. 14 is a representative diagram of an enhanced graphene based coating for automotive vehicles. The graphene enhanced coatings can include the primer, base, and top coatings to prevent corrosion.

All of the compositions and methods disclosed and claimed herein can be made and executed without undue experimentation in light of the present disclosure. While the disclosure may have focused on several embodiments or may have been described in terms of preferred embodiments, it will be apparent to those of skill in the art that variations and modifications may be applied to the compositions and methods without departing from the spirit, scope, and concept of the disclosure. All variations and modifications apparent to those skilled in the art are deemed to be within the spirit, scope, and concept of the disclosure as defined by the appended claims.

1. A composition comprising:
(A) functionalized graphene; and
(B) a binder;
wherein the composition is used as a coating.

2. The composition of claim 1, wherein the binder is a polymeric binder.

3.-5. (canceled)

6. The composition of claim 1, wherein the coating comprises from about 0.5-20 wt % of functionalized graphene.

7. The composition of claim 1, wherein the functionalized graphene comprises one or more functional groups selected from: amino, cyano, hydroxyl, carboxylic acid, isocyanate, aldehyde, epoxide, urea, alkene, aralkene, or anhydride.

8. The composition of claim 1 further comprising a carrier, a filler, a pigment, or a dispersant.

9.-10. (canceled)

11. A composition comprising:
(A) functionalized graphene; and
(B) a resin.

12. The composition of claim 11, wherein the composition is used as a coating.

13. (canceled)

14. The composition of claim 11, wherein the coating is a coating on a steel substrate, an automobile, a ship, a concrete surface, a marine structure, or a construction structure.

15. The composition of claim 11, wherein the functionalized graphene contains at least one chemical group selected from: amine, cyano, carboxylic acid, hydroxyl, isocyanate, aldehyde, epoxide, urea, or anhydride.

16. The composition of claim 15, wherein the functionalized graphene contains at least one chemical group which comprises a nitrogen containing group.

17. The composition of claim 11, wherein the resin is a phenolic resin, a polyester resin, a polyol resin, an epoxy resin, or an isocyanate resin.

18. (canceled)

19. The composition of claim 11, wherein the composition further comprises a filler, a pigment, or an accelerator.

20.-21. (canceled)

22. The composition of claim 11, wherein the coating is from about 5 μm to about 300 μm thick.

23.-24. (canceled)

25. A composition comprising:
(A) a functionalized graphene; and
(B) a resin,
wherein the functionalized graphene is reacted with the resin to form a polymeric resin consisting essentially of functionalized graphene and resin repeating units and the resultant polymeric resin is used as a coating.

26. The composition of claim 25, wherein the functionalized graphene comprises one or more chemical groups selected from: amine, cyano, carboxylic acid, hydroxyl, isocyanate, aldehyde, epoxide, urea, alkene, aralkene, or anhydride.

27. The composition of claim 25, wherein the resin is an epoxy, isocyanate, polyol, polyester, or phenolic resin.

28. The composition of claim 25, wherein the functionalized graphene comprises
(1) one or more amine, carboxylic acid, hydroxy, or urea groups when the resin is an isocyanate resin;
(2) one or more amine, anhydride, carboxylic acid, or hydroxyl groups when the resin is an epoxy resin;
(3) one or more isocyanate groups when the resin is a polyol resin;
(4) one or more alkene, aralkene, or anhydride groups when the resin is a polyester resin;
(5) one or more aldehyde groups when the resin is a phenolic resin.

29. (canceled)

30. The composition of claim 25, wherein the composition further comprises a filler, a pigment, or an accelerator.

31. (canceled)

32. The composition of claim 30, wherein the accelerator is a metal catalyst, a basic catalyst, an acid catalyst, an azide compound, or a peroxide.

33. The composition of claim 25, wherein the coating is from about 5 μm to about 300 μm thick.

34.-35. (canceled)
